(19) United States
(12) Patent Application Publication
(10) Pub. No.: US 2026/0118529 A1
(43) Pub. Date: Apr. 30, 2026

(54) TUBULAR AZIMUTHAL GAMMA RAY TOOL AND APPLICATIONS THEREOF

(71) Applicant: CHINA PETROLEUM & CHEMICAL CORPORATION, Beijing (CN)

(72) Inventors: Sheng ZHAN, Houston, TX (US); Jeremy ZHANG, Houston, TX (US)

(21) Appl. No.: 19/003,338

(22) Filed: Dec. 27, 2024

Related U.S. Application Data
(60) Provisional application No. 63/615,965, filed on Dec. 29, 2023.

(51) Int. Cl. G01T 1/20; G01V 5/12

(52) U.S. Cl. CPC G01T 1/2006; G01V 5/12

(57) ABSTRACT

A gamma ray measurement tool has a tubular shell, a gamma ray detector disposed in the tubular shell, and a shield disposed between the tubular shell and the gamma ray detector. The gamma ray detector has a scintillation crystal coupled to a photomultiplier tube, and the shield has a open window configured to allow gamma rays to pass through and reach the scintillation crystal. Further, the tubular shell has a first axis in the longitudinal direction, and the gamma ray detector has a second axis in the longitudinal direction, the first axis and the second axis do not coincide with each other, and a distance between the scintillation crystal and an inner surface of the tubular shell through the window is shorter than a distance between the scintillation crystal and a portion of the tubular shell covered by the shield.

### CROSS-REFERENCE TO RELATED APPLICATION

This application claims priority to U.S. Provisional Patent Application having Ser. No. 63/615,965, filed on Dec. 29, 2023, which is incorporated herein by reference in its entirety.

### BACKGROUND

Gamma ray logging is a method for measuring naturally occurring gamma radiation to characterize the rock (formation) or sediment in a borehole. Different types of rock emit different amounts of natural gamma rays. For example, shales usually emit more gamma rays than other sedimentary rocks, such as sandstone, salt, coal, dolomite, or limestone. Such differences in radioactivity among rocks allow using the gamma ray log from a gamma ray measurement tool to distinguish different types of rocks.

Azimuthal gamma ray logging is to record the azimuthal radioactivity of natural gamma rays with one or more gamma ray detectors from a gamma ray measurement tool. Directional detectors are either located in a notched drilling collar or inside the centralized mud channel of a drilling pipe to measure azimuthal values of natural gamma rays while the logging tool is rotating in the process of logging while drilling.

The difference in the azimuthal gamma rays when the bit is approaching the boundary of two formations can be utilized in geosteering of the drilling direction so that the borehole remains in the reservoir formation. As it is shown in FIG. 1, the azimuthal gamma rays binned in four sectors (up, down, left and right) as an example. FIG. 1 contains Panels A-D. Each panel has a graph showing the gamma ray count at different depths of investigation on top and a schematic drawing illustrating the drilling direction. A low radioactivity formation is disposed between two high radioactivity formations, forming an upper boundary and a lower boundary therebetween.

In FIG. 1, Panel A, the count of upper gamma ray is higher than the lower gamma ray count and the upper gamma ray count increases first, which indicates that the drill bit is drilling near the upper boundary in a direction from the low radioactivity formation to the high radioactivity formation.

In FIG. 1, Panel B, the count of upper gamma ray is higher than the count of lower-gamma ray but the lower-gamma ray count decreases first, indicating the drill bit is drilling near the upper boundary in a direction from the high radioactivity formation to the low radioactivity formation.

In FIG. 1, Panel C, the count of upper gamma ray is lower than the count of lower gamma ray and the upper gamma count decreases first. The drill bit is drilling near the lower boundary and moving in a direction from the high radioactivity formation to the low radioactivity formation.

In FIG. 1, Panel D, the count of up-gamma rays is lower than the lower-gamma ray count but the lower-gamma ray count increases first, which indicates that the drill bit is drilling near the lower boundary in a direction from the low radioactivity formation to the high radioactivity formation.

Conventionally azimuthal gamma ray detectors are installed at different azimuthal angles, e.g. 0° and 180° for two detectors or 0°, 120°, 240° for three detectors. FIG. 2 shows a cross section of a gamma ray tool having three detectors installed in a collar at 0°, 120°, and 240°, respectively.

FIG. 3 shows the cross-section of an exemplary tubular gamma ray detector. The gamma ray detector contains a scintillation crystal installed in the center of the tubular shell of the detector. The scintillation crystal absorbs gamma rays and converts a part of the energy to visible light or UV. Between the tubular shell and the scintillation crystal is a shielding that has a window. The shield blocks gamma rays from most angles but lets in gamma ray radiations through the window. The tubular gamma ray tool is deployed inside a drill collar. A mud channel exists between the tubular shell of the gamma ray tool and the drill collar. Since gamma rays can only reach the detector through the window, the measurement of gamma rays is directional.

FIG. 4 is a schematics showing the cross section of two gamma ray detectors deployed in tandom. In addition to the scintillation crystal and the shield, each detector further contains a photomultiplier tube (PMT) and associated electronics. The PMT receives light from the scintillation crystal and generates photoelectrons. The associated electronics multiplies, amplifies, and outputs electric signals in the form of a charge or a current.

The advantage of the tubular-based gamma ray tool as shown in FIGS. 3-4 is that it's easy to install and replace the instrument. However, the tubular-based design requires that the gamma ray tool be installed in the center of the drill collar, which increases the distance between the detector and the formation. The mud channel and drill pipe wall blocks a portion of the gamma rays and thereby reduces the sensitivity of the detector.

Moreover, when more than one detectors are deployed in tandom and connected in series, the axial distance between the adjacent scintillation crystals are relatively large. In this case, each detector is reading signals at different measurements depths in the formation, which often requires corrections to compensate for the measurement depth difference. The corrected gamma ray count is then binned according to the azimuthal angle at same depth for further analysis.

Therefore, there is a need for an azimuthal gamma ray measurement tool that not only can be easily installed and replaced, but also has detectors installed closer to the formation. Moreover, there is also a need to increase the detection efficiency and to reduce the axial distance between the detectors at the same time.

### SUMMARY

According to one of the exemplary embodiments of the current disclosure, a gamma ray measurement tool has a tubular shell, a gamma ray detector disposed in the tubular shell, and a shield disposed between the tubular shell and the gamma ray detector. The gamma ray detector has a scintillation crystal coupled to a photomultiplier tube, and the shield has an open window configured to allow gamma rays to pass through and reach the scintillation crystal.

Further, the tubular shell has a first axis in the longitudinal direction, and the gamma ray detector has a second axis in the longitudinal direction, the first axis and the second axis do not coincide with each other, and a distance between the scintillation crystal and an inner surface of the tubular shell through the window is shorter than a distance between the scintillation crystal and a portion of the tubular shell covered by the shield.

According to another embodiment of the current disclosure, the distance between the first axis and the second axis is at least one time of the diameter of the scintillation crystal and at most five times, preferably three times, of the diameter of the diameter of the scintillation crystal.

According to a further embodiment of the current disclosure, the thickness of the shield is not uniform, The thickness is lowest at a periphery of the open window and highest in a portion of the shield opposite to the window.

According to another exemplary embodiment of the current disclosure, the gamma ray measurement tool has two identical gamma ray detectors in a way that the open windows in the two gamma ray detectors are offset by 180° C.

According to a still another embodiment, the gamma ray measurement tool contains a first and a second gamma ray detectors. The open window in the second gamma ray detector opens in a direction that is opposite to the direction of the open window of the first gamma ray detector. According to an aspect of the current disclosure, the two gamma ray detectors in the gamma ray measurement tool are arranged in such a way that an axial distance between the scintillation crystals in the two gamma ray detectors are smallest. Put in another way, each of the two detectors has a first end and a second end, an axial distance between the first end and the scintillation crystal in each detector is shorter than an axial distance between the second end and the scintillation crystal, and wherein the first ends of the two detectors are installed adjacent to each other.

### BRIEF DESCRIPTION OF DRAWINGS

FIG. 1 illustrates the relationship between the drilling direction and gamma ray counts when the gamma ray tool crosses a boundary between a high radioactivity formation and a low radioactivity formation.

FIG. 2 is a cross-sectional view of a conventional LWD collar-based azimuthal tool with three gamma ray detectors.

FIG. 3 shows a cross-sectional view of a conventional tubular-based azimuthal gamma ray tool disposed inside a drill collar.

FIG. 4 shows a cross-section view of a convention tubular-based azimuthal gamma ray tool having two gamma ray detectors of FIG. 3 arranged in tandem.

FIG. 5 shows a cross section of an embodiment tubular-based azimuthal gamma ray tool disposed inside a drill collar.

FIG. 6 shows a cross-sectional view along the axial direction of a gamma ray tool having two tubular-based azimuthal ray detectors of FIG. 5.

FIG. 7A is a view of the A-A cross section of the tool in FIG. 6.

FIG. 7B is a view of the B-B cross section of the tool in FIG. 6

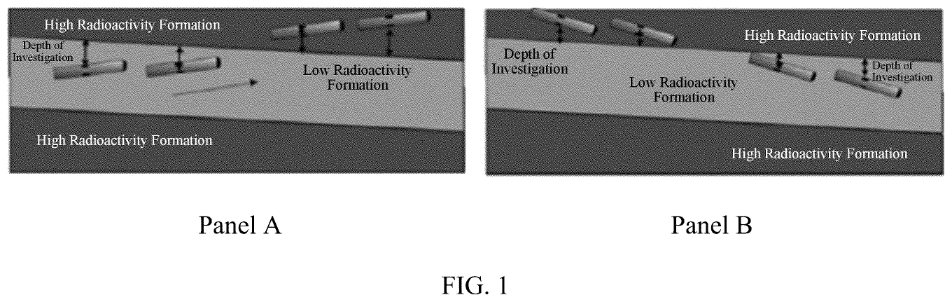

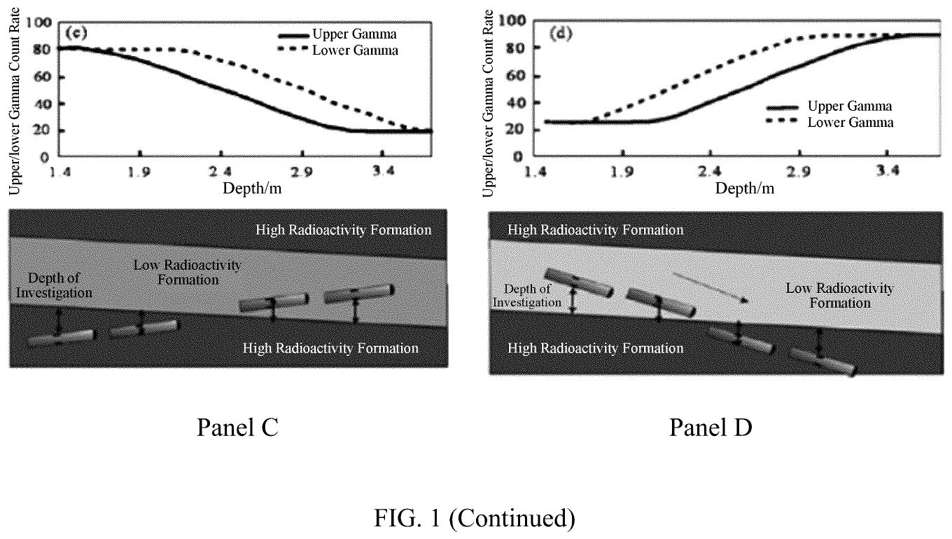

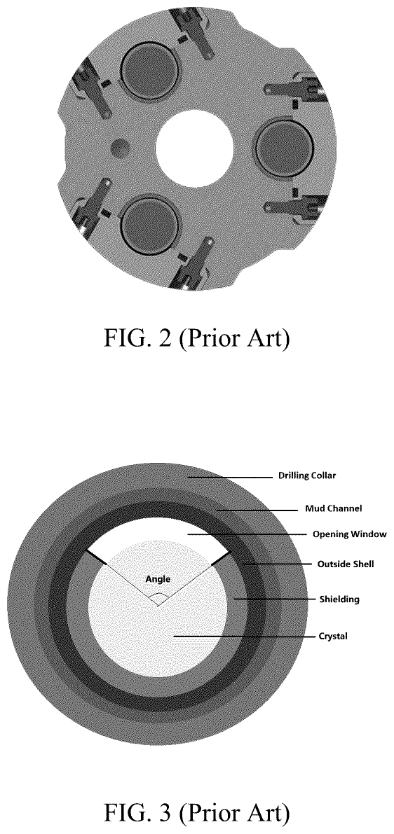

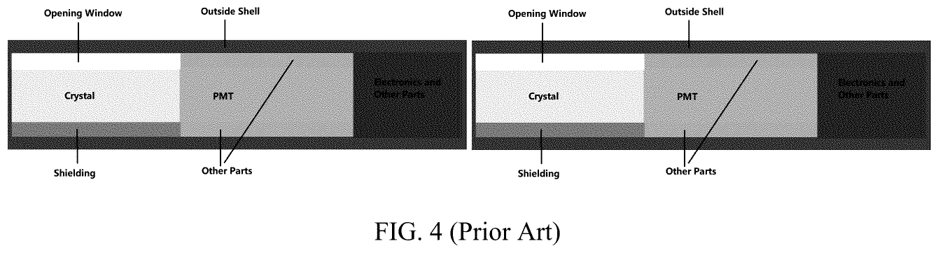

### DETAILED DESCRIPTION OF EMBODIMENT

The Figures (FIG.) and the following description relate to the embodiments of the present disclosure by way of illustration only. It should be noted that from the following discussion, alternative embodiments of the structures and methods disclosed herein will be readily recognized as viable alternatives that may be employed without departing from the principles of the claimed disclosures.

Used herein “detector” and “gamma ray detector” are used exchangeable, both referring an azimuthal gamma ray detector that has a scintillation crystal sensitive to gamma ray.

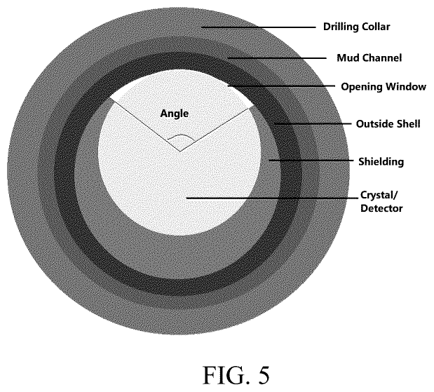

FIG. 5 illustrates an exemplary tubular-based gamma ray tool disposed in a drill collar, which has a detector with the scintillation crystal installed off the longitudinal axis of the tubular shell of the gamma ray tool. The distance between the longitudinal axis of the detector and the longitudinal axis of the tubular shell is between 1-5 times, preferably 1-3 times, the diameter of the scintillation crystal in the direction perpendicular to the longitudinal axis of the detector.

The off-center arrangement of the gamma ray detector reduces the distance between the scintillation crystal and the formation through the window (i.e., front of the scintillation crystal) in the shield and reduces the thickness of the shield around the window. It also increases the thickness of the shield in the direction opposite the window in the back of the scintillation crystal. Accordingly, the detector has an increased ratio of the gamma ray count between the front and the back of the scintillation crystal, which can significantly increase the sensitivity of the gamma ray detector.

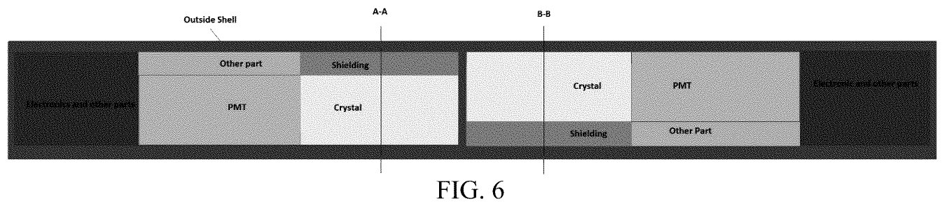

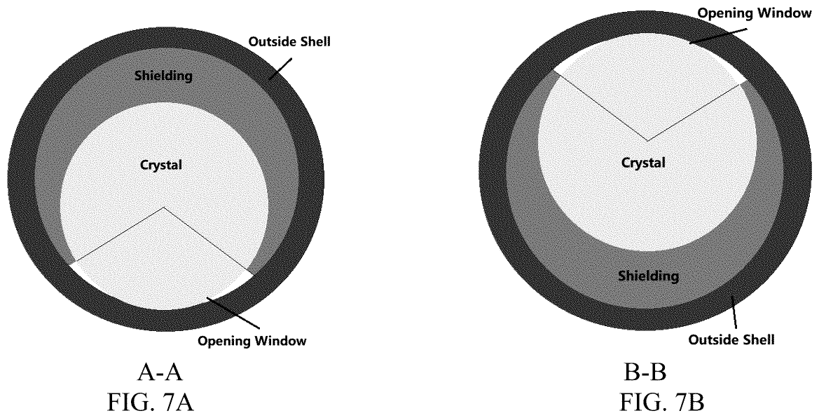

FIG. 6 shows another example tubular gamma ray tool having two detectors arranged in tandem. In this example, the scintillation crystals of two detectors are adjacent to each other, which minimizes the axial distance between the two scintillation crystals. In this way, the readings of natural gamma radiation from the two azimuthal detectors have substantially the same measurement depth and therefore can be compared directly to evaluate the drilling direction even without depth correction.

Further, the two detectors are arranged in 180 degrees in the azimuthal angle. That is, the windows of the two detectors open to opposite directions. When one detector faces up (0 degree), the other faces down (180 degrees). This helps to maximize the reading difference between the two azimuthal detectors when the tool enters the boundary of the two formations or formation is not homogenous in different directions.

In additional embodiments, the gamma ray measurement tool may have more than two detectors arranged in tandem. In that case, the first and the second detectors have their scintillation crystals installed adjacent to each other so that they have the same measurement depth. The windows of the more than two detectors are distributed evenly along the circumferential direction of the gamma ray tool. When there are three detectors in tandem, the azimuthal angels of the window can be 0°, 120°, and 240°.

In another variation of the embodiments, the gamma ray detector may contain more than one windows and more than one scintillation crystals. The scintillation crystals are shielded from each other by an internal shield inside the detector.

While in the foregoing specification this disclosure has been described in relation to certain preferred embodiments thereof, and many details have been set forth for purpose of illustration, it will be apparent to those skilled in the art that the disclosure is susceptible to alteration and that certain other details described herein can vary considerably without departing from the basic principles of the disclosure. In addition, it should be appreciated that structural features or method steps shown or described in any one embodiment herein can be used in other embodiments as well.

We claim:

1. A gamma ray measurement tool, comprising a tubular shell, a gamma ray detector disposed in the tubular shell, and a shield disposed between the tubular shell and the gamma ray detector,
wherein the gamma ray detector comprises a scintillation crystal coupled to a photomultiplier tube, and the shield has an open window configured to allow gamma rays to pass through and reach the scintillation crystal, and
wherein the tubular shell has a first axis in the longitudinal direction, and the gamma ray detector has a second axis in the longitudinal direction, the first axis and the second axis do not coincide with each other, and a distance between the scintillation crystal and an inner surface of the tubular shell through the window is shorter than a distance between the scintillation crystal and a portion of the tubular shell covered by the shield.

2. The gamma ray measurement tool of claim 1, wherein a thickness of the shield varies along the circumferential direction of the gamma ray measurement tool.

3. The gamma ray measurement tool of claim 2, wherein the thickness is lowest at a periphery of the open window and highest in a portion of the shield opposite to the window.

4. The gamma ray measurement tool of claim 1, wherein a distance between the first axis and the second axis is at least one time of a diameter of the scintillation crystal.

5. The gamma ray measurement tool of claim 4, wherein the distance between the first axis and the second axis is not larger than three times the diameter of the scintillation crystal.

6. The gamma ray measurement tool of claim 1, comprising two of the gamma ray detectors installed in the tubular shell in a way that the open windows in the two gamma ray detectors are offset by 180° C.

7. The gamma ray measurement tool of claim 1, comprising a second gamma ray detector, wherein the open window in the second gamma ray detector opens to a direction that is opposite to the open window of the gamma ray detector.

8. The gamma ray measurement tool of claim 6, wherein the two gamma ray detectors are arranged in such a way that an axial distance between the scintillation crystals in the two gamma ray detectors are smallest.

9. The gamma ray measurement tool of claim 4, wherein each of the two detectors has a first end and a second end, an axial distance between the first end and the scintillation crystal in each detector is shorter than an axial distance between the second end and the scintillation crystal, and wherein the first ends of the two detectors are installed adjacent to each other.
